(19) United States
(12) Patent Application Publication
(10) Pub. No.: US 2007/0034702 A1
(43) Pub. Date: Feb. 15, 2007

(54) Heating system

(76) Inventors: James M. Rixen, Portland, OR (US); Cristian Murgu, Coquitlam (CA)

Correspondence Address: KOLISCH HARTWELL, P.C., 200 PACIFIC BUILDING, 520 SW YAMHILL STREET, PORTLAND, OR, 97204, US

(21) Appl. No.: 11/478,518

(22) Filed: Jun. 28, 2006

Related U.S. Application Data
(63) Continuation of application No. 11/284,451, filed on Nov. 21, 2005, now abandoned.
Application No. 11/284,451 is a continuation of application No. 10/438,791, filed on May 14, 2003, now abandoned.
Application No. 10/438,791 is a continuation-in-part of application No. 10/421,365, filed on Apr. 22, 2003.
(60) Provisional application No. 60/380,586, filed on May 14, 2002.

(51) Int. Cl. B60H 1/00

(52) U.S. Cl. 237/2 A

(57) ABSTRACT

A water heating system uses a heated fluid storage tank to deliver a continuous supply of water heated to a desired temperature, such as between 100°-130° F. The system also includes a furnace with altitude-sensitive control circuitry to provide multiple sources of heat for the heating system in the most effective way given the altitude at which the system is located. The system also includes a micro-controller that adjusts certain system components in response to changes in atmospheric pressure conditions that are measured by an atmospheric-pressure sensor component. There is also an automatic-air-bleeder subsystem with an optical or ultrasonic sensor mounted adjacent a suitable air accumulator. Also included is an air-release solenoid and a fuel return line.

### CROSS-REFERENCE TO RELATED APPLICATIONS

This application is a continuation of U.S. patent application Ser. No. 11/284,451, filed Nov. 21, 2005 and entitled “Heating System”, which is a continuation of U.S. patent application Ser. No. 10/438,791, filed May 14, 2003 and entitled “Heating System”, which is a continuation-in-part of U.S. patent application Ser. No. 10/421,365, filed Apr. 22, 2003 entitled “Heating System”, and incorporated herein by reference. This application also claims priority to U.S. Provisional Patent Application Ser. No. 60/380,586, filed May 14, 2002 and entitled “Heating System”.

### FIELD OF THE INVENTION

The present invention relates generally to heating systems, and more specifically, to a hydronic heating system and method for recreational-vehicle (RV), marine and home heating applications that includes a system for altitude compensation for diesel-fire heaters, and an automatic air bleeder for removing unwanted air bubbles from heater fuel.

### BACKGROUND OF THE INVENTION

Heating systems for campers and recreational vehicles are widely known. Conventional water heating systems for recreational vehicles generally fall into two classes. The first class includes systems that have a heating element(s) that extends into a cavity that holds several gallons of water. The heating element ultimately heats the entire volume of water in the cavity. Drawbacks to this first class include a lack of continuous hot water. In addition, the first class of systems takes a relatively long period of time to heat water. The second class involves systems that heat a relatively small volume of water with a gas or electric heating device. Conventional systems of the second class include propane, or other open flame “flash furnace” heating systems that directly heat domestic water supplied to the system. Open-flame systems like these are relatively expensive and relatively unsafe when used in a recreation vehicle. In addition, a propane system is ineffective to provide a constant supply of hot water.

For heating devices used in the above heating systems, there are certain problems caused when changes in atmospheric pressure (due to changes in altitude or weather) undesirably affects heating-fuel combustion. Conventional heating devices (heaters) are not constructed to change the combustion parameters, and as a result they do not perform optimally when such changes occur. The result is that heater exhaust emissions increase causing smoke, and giving off undesirable smells/odors. Carbon also accumulates on the heater-burner tube and other system components. Overall, conventional heater performance/efficiency becomes low, maintenance becomes expensive, and ultimately the heater becomes damaged.

Accordingly, for applications where the heater is used in different atmospheric pressure conditions, there is a need for the heater to be constructed to adjust combustion parameters based upon changes in atmospheric pressure to maintain low exhaust emissions (e.g. Recreational Vehicle (RV) and household applications), maintain optimal performance, and reduce the risk of heater damage or need for maintenance.

Generally, conventional diesel-fired heaters can characterized as high-pressure and low-pressure, where the pressure (high or low) refers to the pressure between the fuel pump and the fuel-atomizing device associated with the heater. In connection with low-pressure diesel-fired heaters for RV, there have been conventional proposals to deal with the situation where the RV (and heater) increase altitude by using a so-called zero-pressure regulator and a Venturi fuel-atomizing system to reduce the amount of fuel which is burned in the combustion process at higher altitude. One drawback to this method is that heat output/efficiency drops with each incremental increase in altitude at an approximate rate of 5% for every 3000 ft.

Another problem associated with conventional diesel-fired heaters is that the associated fuel pump supplies fuel that is mixed with undesirable air bubbles. Passing through the fuel-atomizing component of conventional systems, these air bubbles cause gaps in the fuel supply which can cause heater de-activation (so-called “flame out” conditions). When the heater flames out, a white cloud of smoke is generated because conventional control circuitry cannot immediately stop the fuel-delivery subsystem. As a result, fuel is sprayed into a hot combustion chamber for a period of time. This situation causes the smoke, or in the worst case where the fuel re-ignites, explosions.

Objects of the invention include solving the problems associated with changes in atmospheric conditions, and those associated with air bubbles in the heater fuel.

### SUMMARY OF THE INVENTION

The present invention overcomes the drawbacks of conventional systems by providing a water heating system that uses a heated fluid storage tank to deliver a continuous supply of water heated to a desired temperature, such as between 100°-130° F. The system also may combine a heated fluid storage tank with an altitude sensitive burner type furnace to provide multiple sources of heat for the heating system.

To achieve the desired altitude compensation capability, the system includes a controller (preferably a micro-controller) that adjusts certain system components in response to changes in atmospheric pressure conditions that are measured by an atmospheric-pressure sensor component of the invention. For example, for low-pressure-type diesel-fired heaters, the invention is constructed to increase the amount of combustion air in response to a sensed increase in altitude. By increasing the pressure of the compressed air so that changes in altitude will not affect the quantity of fuel absorbed through the heater nozzle (under Venturi effect), the altitude-compensation controller (or circuit) of the invention will adjust the amount of the combustion air by controlling the sped of the combustion fan or the surface (size) of the combustion-air-intake opening. This controller and method maintains a constant heat output regardless of changes in atmospheric pressure such as changes in altitude or weather.

The automatic air bleeder of the invention includes a suitable sensor (such as an optical or ultrasonic one) mounted adjacent a suitable air accumulator (for optical sensors, substantially transparent or clear glass, or a plastic tube are suitable; for ultrasonic sensors, plastic or rubber tubes are suitable). Also included is an air-release solenoid and a fuel return line.

### BRIEF DESCRIPTION OF THE DRAWINGS

FIG. 1 is a schematic diagram of a heating system according to one embodiment of the present invention.

FIG. 2 is a schematic diagram of an altimeter connected to the motor of a fan usable in the heating system of the invention.

FIG. 3 is a schematic diagram of an altimeter with a flash micro-controller of the invention.

FIG. 4 is a schematic diagram of an automatic air-bleeder feature of the invention.

FIG. 5 is a schematic diagram showing a heater feature of the invention for use in applications for low-pressure-type heaters and that shows altitude compensation via fan-speed control.

FIG. 6 is a schematic diagram showing a heater feature of the invention for use in applications for low-pressure-type heaters and that shows altitude compensation via control of the combustion-air-intake surface.

FIG. 7 is a schematic diagram showing a heater feature of the invention for use in applications for high-pressure-type heaters and that shows altitude compensation via controlling the flow of fuel from the fuel pump.

FIG. 8 is a schematic diagram showing a heater feature of the invention for use in applications for high-pressure-type heaters and that shows altitude compensation via control of the combustion-air-intake surface.

FIG. 9 is a schematic diagram showing a heater feature of the invention for use in applications for high-pressure-type heaters and that shows altitude compensation via fan-speed control.

### DETAILED DESCRIPTION AND BEST MODE OF THE INVENTION

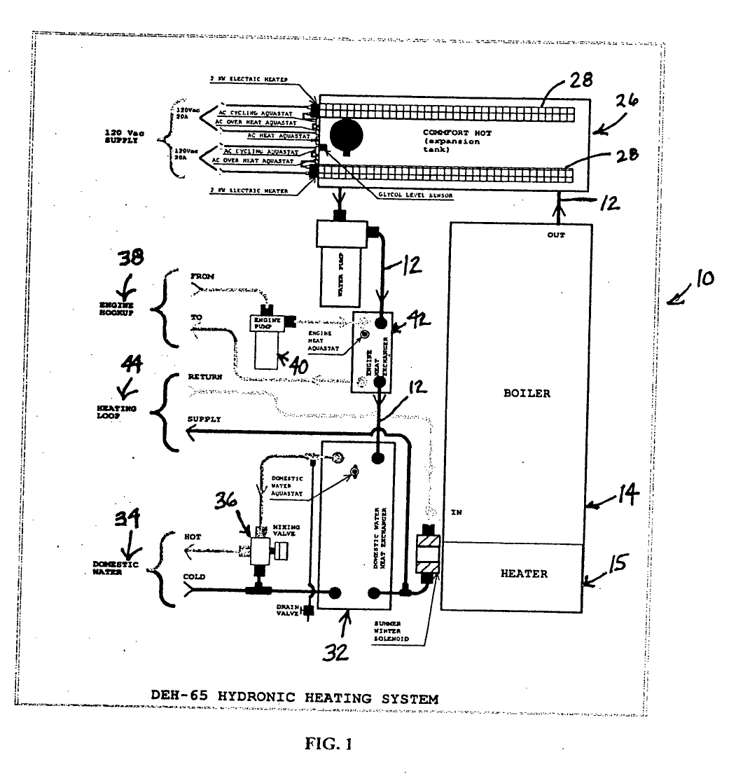

A heating system according to one embodiment of the present invention is shown at 10 in FIG. 1. The heating system may be used to provide a continuous supply potable hot water, and to provide heat to a coach or recreational vehicle. Additionally, the heating system may be used to warm the engine block of a coach in cold weather climates to make the engine easier to start.

Heating system 10 uses a main heating fluid circuit 12 to provide heat for the potable hot water system, the coach heater system, and to warm the coach engine block in cold climates. A main circuit pump 13 circulates heating fluid through circuit 12. The main heating fluid circuit 12 includes a heater/boiler 14 configured to heat a volume of heating fluid. Typically, the heater/boiler is configured to heat a heating fluid such as glycol; however, a mixture of glycol and water or other suitable high-heat-capacity liquid may be used as a heating fluid.

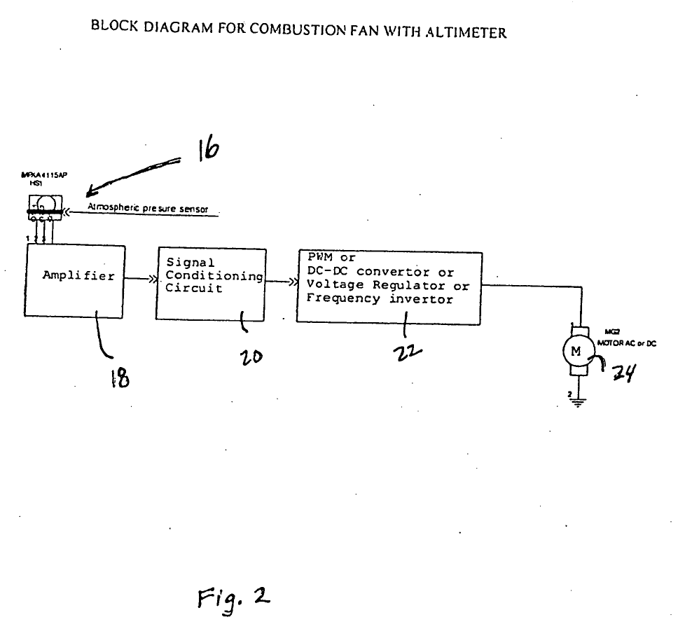

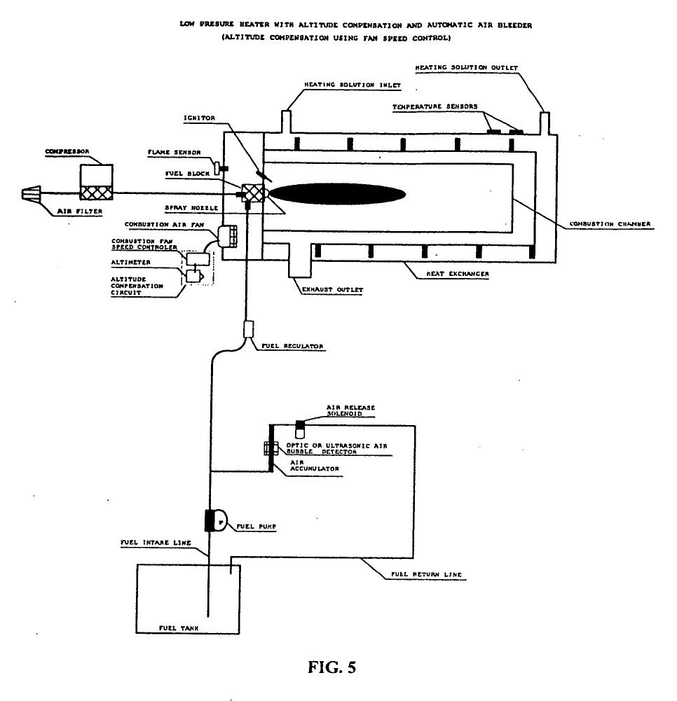

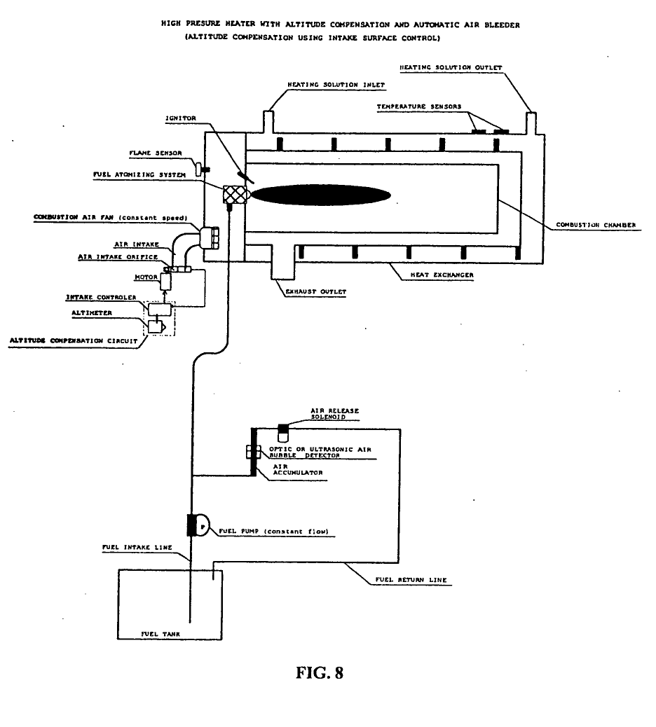

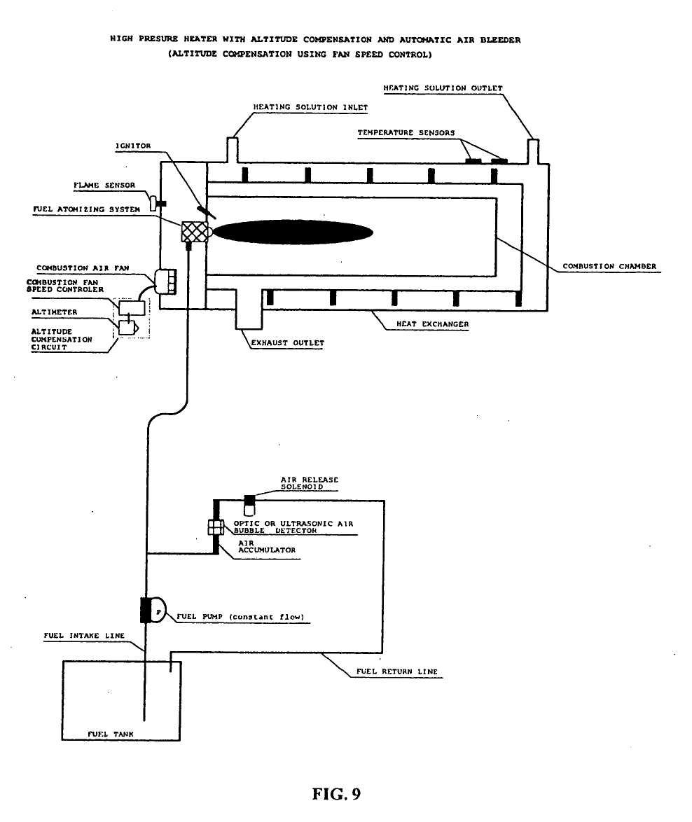

Still referring to FIG. 1, a diesel-fired burner 15 may heat heater boiler 14. A variable speed fan may provide burner 15 with air for combustion of diesel fuel. The variable speed fan may be connected to an atmospheric pressure sensor, as shown at 16 in FIG. 2. Atmospheric sensor 16 produces an electronic signal based on the external atmospheric pressure. The electronic signal is amplified at amplifier 18 and the signal is then processed in a signal-conditioning circuit 20. Additional signal conditioning may be applied at 22 in the form of a PWM, DC-DC converter, voltage regulator, or frequency inverter. Finally the signal is sent to a variable-speed motor 24. Variable-speed motor 24 drives a fan, as shown in FIGS. 5-9, that supplies air for combustion to diesel-fired burner 15. As the atmospheric pressure sensor senses lower ambient air pressure it may increase the speed of variable-speed motor 24. Increasing the speed of the motor increases the amount of air blown in to the combustion chamber of the burner. The atmospheric pressure sensor may continuously vary the speed of the fan in response to changes in the atmospheric pressure.

Alternatively, the atmospheric pressure sensor may speed up the fan to increase the flow of air to the burner at discrete altitudes where ambient air pressure drops below specific thresholds. For example, from sea level to 2000 ft. the fan speed may be low. Above 2000 ft. up to around 6000 ft. the fan speed may be medium or higher than the low setting. Above 6000 ft. the fan speed may be high to compensate for the lower density of air at that altitude.

Referring again to FIG. 1, main heating fluid circuit 12 further includes a heated expansion tank 26. Tank 26 may be heated by electric heating elements 28. A suitable heated expansion tank 26 is available commercially under the trade name COMFORTHOT™ Typically, heating elements 16 are 2-kilowatt electric heating elements; however, any suitable heating element may be used. Heating elements 28 are inserted into tank 26 in a manner similar to a conventional residential electric hot water heater. Heat energy is stored in the tank 26, so in a sense tank 26 acts as a heat battery for the heating system capable of providing instant heat energy to any system that requires it. The electric elements maintain the heating fluid at an elevated temperature without a large energy demand, while there is little or no demand for heat from the system. As demand for heat increases burner 15 of tank 26 is activated and thus provides additional heat energy for heating water ultimately for use as shower water or as heating fluid that is used to heat the vehicle cabin or engine block.

Main heating fluid circuit 12 also includes a domestic water heat exchanger 32. Heating fluid in the main heating circuit flows through domestic water heat exchanger 32 to heat water. Water in the domestic water system is heated by transferring heat from the heating fluid to domestic water in heat exchanger 32.

Domestic water system 34 supplies cold water to heat exchanger 32 for heating. The heated water exits heat exchanger 32 and flows to a mixing valve 36 that prevents hot water from exceeding a certain temperature by mixing hot water from heat exchanger 32 with cold water from the domestic water system.

Still referring to FIG. 1, heating system 10 includes an engine-hookup loop 38, an engine-hookup-loop pump 40 and an engine-heat exchanger 42. Main heating fluid circuit 12 flows through one side of engine-heat exchanger 42. The engine-hookup loop and engine-heat exchanger may be used to extract excess heat from the engine of the coach while it is operating. Opening engine-hookup loop 38 supplies engine coolant to one side of heat exchanger 42. Heat exchanger 42 transfers engine heat to the heating fluid in main heating fluid circuit 12. Extracting heat energy from the coach's engine reduces the energy demands of the heating system.

Another benefit of engine-hookup loop 38 is that the heating system may be used to warm the engine block of the coach prior to starting the engine in cold climates. By pumping engine coolant through engine-heat exchanger 42 at the same time the heating fluid is circulating in circuit 12, heat is provided to the engine of the recreational vehicle. Preheating an engine block in cold climates makes it easier to start and reduces wear and tear on the engine.

A cabin-heating loop 44 may by attached to main-heating-fluid circuit 12 that supplies heating fluid to heating fans (not shown) in the cabin of the vehicle to provide the cabin of the vehicle with heat. A cabin-loop solenoid 46 opens and closes the cabin loop to selectively provide the cabin with heat. Fluid pump 13 provides the pressure to circulate heating fluid through the cabin-heating loop when the cabin loop solenoid is open. Each heating fan acts as a heat exchanger to warm air in the cabin.

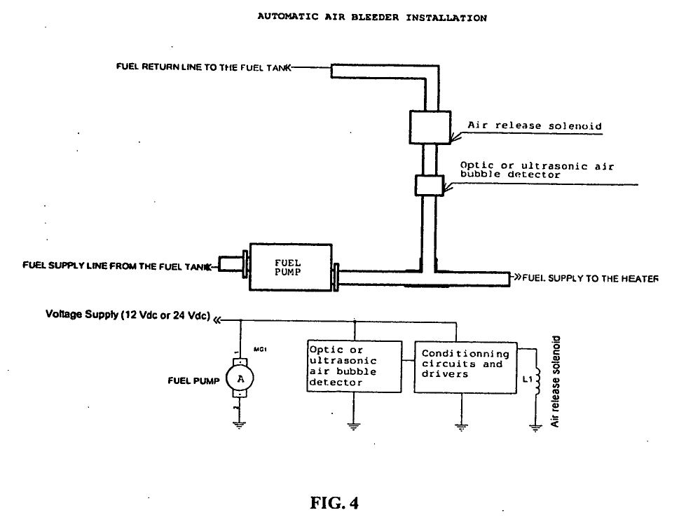

Referring to FIG. 4, an air bleeder subsystem is shown that is connectable within the fuel line that draws fuel for the diesel-fired heater (burner)(see FIGS. 5-9 below the fuel regulator and between the fuel pump and the fuel atomizing system). The air bleeder subsystem includes any suitable sensor, such as an optical air/air-bubble detector or ultrasonic sensor configured to detect a bubble in the fuel line. When a bubble is detected an air release solenoid opens the return line to bleed air back to the tank or out a vent. The bubble detector then detects that the bubble is no longer present and the solenoid closes the return line. The air bleeder enables the burner to run safely. Large air bubbles can extinguish the burner flame causing clouds of white smoke, exhaust emissions, carbon built-up and increase the cost of maintenance. In addition, re-igniting the burner flame repeatedly can damage the burner and cause premature wear.

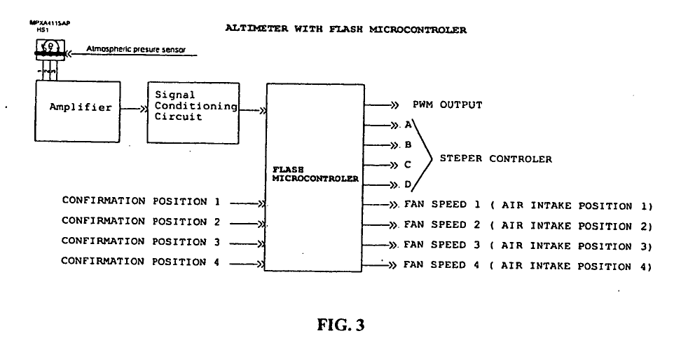

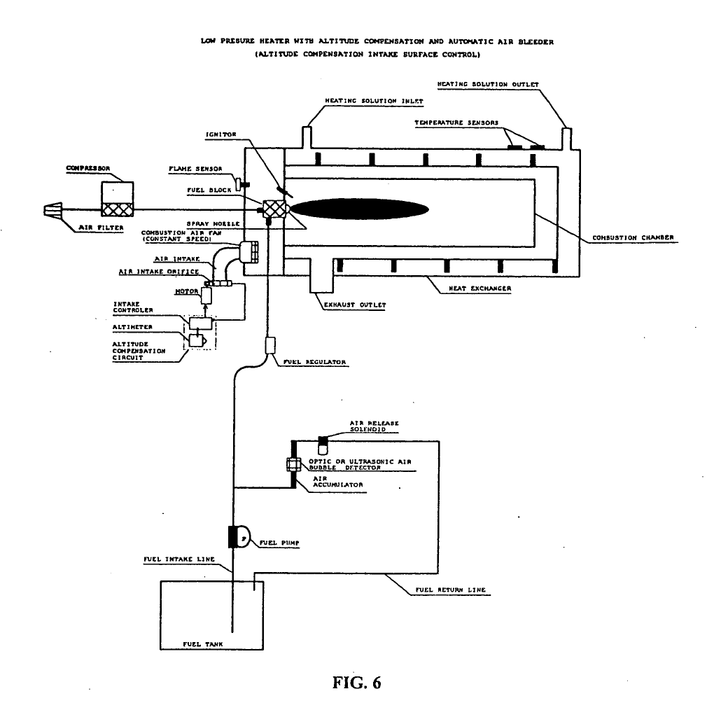

Referring to FIGS. 5-6, the heating system of the invention is shown including the micro-controller (FIG. 3). The heating system may be thought of as a heat-management system designed to optimize three sources of heat. Heat may be generated from a vehicle engine, a diesel furnace associated with a vehicle, or an electric-heating element. Heat is stored in heating fluid and used either to heat water (to be used by vehicle users for showering/washing) or to heat desired areas of the vehicle by directing the heating fluid through associated pipes. A control board is used to control delivery of heat and other decisions about the heat-management system. For example, the system may activate various heat sources to respond to desired heat demands, such as a requirement for hot shower water. Additionally, the control board may be configured to select one of several heat sources (for example, electricity via a suitable AC outlet, a burner, or from the vehicle engine itself). While the vehicle is operating, the vehicle's engine may be the best most efficient source of heat for the demands of the system. The burner (which may be diesel powered) provides a heat source where electricity is unavailable. The system may monitor a variety of sensors for determining the level and temperature of heating fluid (e.g. glycol) in the heating system.

### Altitude Compensation Feature of System and Method Invention

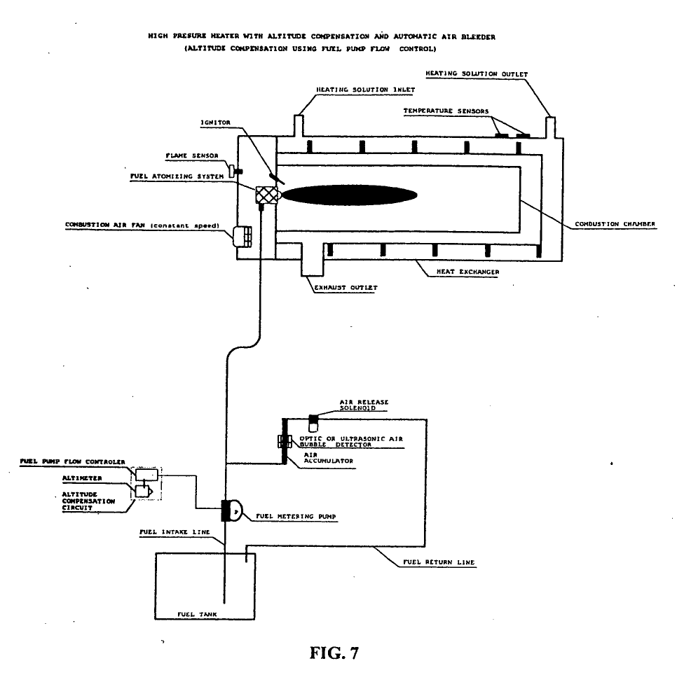

Still referring to FIGS. 5-9, the heating system of the invention is shown for use with either low-pressure or high-pressure diesel-fired heaters (FIGS. 5-6 for low-pressure ones and FIGS. 7-9 for high-pressure ones). Referring to FIG. 5, an electronic atmospheric pressure sensor is connected to a micro-controller via an amplifier and suitable auxiliary conditioning circuitry. The controller is programmed to control the speed of a combustion fan (which provides a quantity of combustion air) or to control the surface/size of an air-intake opening while maintaining the speed of the combustion fan constant. The micro-controller is suitably programmed automatically to: (i) increase the speed of the combustion fan or the surface of the air-intake opening (also referred to as an orifice) upon receiving signal information from the altimeter/atmospheric-change sensor that the atmospheric pressure is lower (higher altitude or cold weather); or (ii) decrease the speed of the combustion fan or the surface of the air-intake opening if the altimeter sends signal information that atmospheric pressure is higher (lower altitude/warmer weather). In other words, based upon signal information from the altimeter that an incremental change in atmospheric pressure has occurred, the micro-controller is constructed automatically to change the speed of the combustion fan or the surface of the air intake orifice (increase for higher altitude/colder weather or decrease for lower altitude/warmer weather).

The adjustment to the combustion air (speed of the combustion fan or surface of the air intake) is experimentally determined for each application and then suitably stored in the memory of the micro-controller via suitable data-entry components such as a keypad. Using a micro-controller (and preferably a flash micro-controller) and customizable software for programming the micro-controller, the same hardware can be used for all the possible applications of low- or high-pressure heaters.

According to the system and method of the invention, for high-pressure heaters the fuel delivered to the fuel-atomizing subsystem is maintained substantially constant relative to atmospheric-pressure changes (altitude or weather changes). To maintain the same heat output, the same system and method as described for low-pressure heaters is utilized. If the desired application calls for lower heat output in lower atmospheric pressure conditions, the system and method of the invention is constructed to control the amount of fuel delivered using the same hardware as described above and shown in FIGS. 5-9 (atmospheric pressure sensor, amplifier, conditioning circuitry and micro-controller) in conjunction with a fuel metering device such as a fuel-metering pump or a fuel-metering valve.

### Automatic Air Bleeder

Referring back to FIG. 4, the automatic air bleeder of the invention includes a suitable sensor (such as an optical or ultrasonic one) mounted adjacent a suitable air accumulator (for optical sensors, substantially transparent or clear glass, or a plastic tube are suitable; for ultrasonic sensors, plastic or rubber tubes are suitable). Also included is an air-release solenoid and a fuel return line.

To operate the automatic air bleeder, once the air in the air accumulator tube reaches the level of the sensor, a pulse is generated by the conditioning circuitry and the air release solenoid will be open for short time to release the air accumulated into the air accumulator. The duration of the pulse generated by the conditioning circuitry is proportional to the size of the air bubble detected. A return-fuel line is mandatory for safety reasons because when the air-release solenoid opens, a small amount of fuel is released back into the fuel tank. If there is no air in the fuel line, then the solenoid is closed (as it is when the fuel pump is deactivated/OFF).

The disclosure set forth above encompasses multiple distinct inventions with independent utility. While each of these inventions has been disclosed in its preferred form, the specific embodiments thereof, as disclosed and illustrated herein, are not to be considered in a limiting sense as numerous variations are possible. The subject matter of the inventions includes all novel and non-obvious combinations and sub-combinations of the various elements, features, functions and/or properties disclosed herein.

We claim:

1. A heat management system connectable to a hydronic heating system that includes a combustion fan and a combustion-air-intake opening, comprising:
an atmospheric-pressure sensor capable of sending signal information about changes in atmospheric pressure; and
a controller coupled to the sensor and programmed to control the speed of the combustion fan based upon signal information received from the sensor.

2. The system of claim 1 wherein the controller is programmed to control the size of the opening while maintaining the speed of the combustion fan constant.

3. The system of claim 1 wherein the controller is a micro-controller.

4. The system of claim 2 wherein the controller is a micro-controller.

5. The system of claim 3 wherein the micro-controller is programmed automatically to increase the speed of the combustion fan upon receiving signal information from the sensor that the atmospheric pressure is lower and to decrease the speed of the combustion fan if the sensor sends signal information that atmospheric pressure is higher.

6. The system of claim 4 wherein the micro-controller is programmed automatically to increase the size of the opening upon receiving signal information from the atmospheric-change sensor that the atmospheric pressure is lower and to decrease the size of the opening if the sensor sends signal information that atmospheric pressure is higher.

7. A heat management system connectable to a hydronic heating system that includes a combustion fan and a combustion-air-intake opening, comprising:
an atmospheric-change sensor capable of sending signal information about changes in atmospheric pressure; and
a controller coupled to the sensor and programmed automatically to change the speed of the combustion fan based upon signal information received from the sensor that an incremental change in atmospheric pressure has occurred.

8. The system of claim 7 wherein the controller is programmed to change the size of the opening while maintaining the speed of the combustion fan constant based upon signal information received from the sensor that an incremental change in atmospheric pressure has occurred.

9. A heat management system connectable to a hydronic heating system with control circuitry, comprising:
an automatic air bleeder including a sensor mounted adjacent an air accumulator and structured to send signal information to the control circuitry; and
wherein the control circuitry is coupled to the air bleeder to activate it upon receiving signal information from the sensor.

10. The system of claim 9 wherein the sensor is chosen from the group consisting of an optical or ultrasonic sensor.

11. The system of claim 9 wherein the accumulator is chosen from the group consisting of substantially transparent glass, clear glass, a plastic tube, or a rubber tube.

12. The system of claim 9 further including an air-release solenoid and a fuel return line.

13. The system of claim 10 further including an air-release solenoid and a fuel return line.

14. The system of claim 11 further including an air-release solenoid and a fuel return line.

15. A heat management system connectable to a hydronic heating system that includes a fuel-metering device, comprising:
an atmospheric-pressure sensor capable of sending signal information about changes in atmospheric pressure; and
a controller coupled to the sensor and programmed to control the amount of fuel delivered to the system via the fuel-metering device based upon signal information received from the sensor.
